(19) United States
(12) Patent Application Publication
(10) Pub. No.: US 2018/0278473 A1
(43) Pub. Date: Sep. 27, 2018

(54) METHOD AND APPARATUS FOR ESTABLISHING A SECURE WIRELESS CONNECTION FOR A PROVISIONING OF CONFIGURATION INFORMATION

(71) Applicant: MOTOROLA SOLUTIONS, INC, CHICAGO, IL (US)

(72) Inventors: BO ZHOU, CHENGDU (CN); GUANG-YANG XU, CHENGDU (CN); FEI-HONG CHEN, CHENGDU (CN); XUE-FENG ZHAN, CHENGDU (CN); WEI ZHAO, CHENGDU (CN)

(21) Appl. No.: 15/753,982

(22) PCT Filed: Dec. 7, 2015
(86) PCT No.: PCT/CN2015/096604

§ 371 Date: Feb. 21, 2018

(51) Int. Cl. H04L 12/24; H04W 4/50; H04W 12/04; H04W 76/20

(52) U.S. Cl. CPC H04L 41/0806; H04W 4/50; H04W 76/15; H04W 76/20; H04W 12/04

(57) ABSTRACT

A communication system is provided that securely provisions configuration information to a mobile device without requiring that a shared key (that is, shared with a radio programming device) be pre-loaded on the mobile device. In various embodiments, the mobile device provides a radio programming device with access point connection information via a scanning tool. The radio programming device then uses the access point connection information to access the mobile device when the mobile device is operating as an access point and to provide the mobile device with information for accessing the radio programming device and with an encryption key. The mobile device converts to operation as a client device and then uses the access information and the encryption key to obtain configuration information from the radio programming device.

### FIELD OF THE INVENTION

The present invention relates generally to wireless communication systems and, in particular, to securely provisioning a mobile device with configuration data via a wireless connection.

### BACKGROUND OF THE INVENTION

Typically, when public safety radios, such as Land Mobile Radios (LMRs), are activated for the first time, they are programmed with configuration data via a wireline connection. This is because, in order to safely and securely program the radio, a wireless communication needs to be encrypted, which requires an exchange of an encryption/decryption key. However, since the end customer is not known in advance for a mass-produced radio coming off of a factory line, a customer-specific key cannot be pre-loaded on the radio. On the other hand, if a common initial key is put on the radios coming off of a factory line, then a hacker may obtain the key and sniff and decrypt data the first time that a customer wirelessly programs the radio. Further, typically such configuration data includes the customer's own encryption key, and thus a hacker sniffing a wireless provision of configuration data may be able to obtain the customer's key used in future encrypted communications by the customer's radios, introducing a security hole in the customer's wireless system.

### BRIEF DESCRIPTION OF SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communication system in accordance with various embodiments of the present invention.

FIG. 2 is a block diagram of a mobile device of the communication system of FIG. 1 in accordance with an embodiment of the present invention.

FIG. 3 is a block diagram of radio programming device of the communication system of FIG. 1 in accordance with an embodiment of the present invention.

FIG. 4A is a signal flow diagram illustrating a method executed by the communication system of FIG. 1 in establishing a secure wireless connection between a mobile device and a radio programming device and a provisioning of configuration information over the secure wireless connection in accordance with some embodiments of the present invention.

FIG. 4B is a continuation of the signal flow diagram of FIG. 4A illustrating a method executed by the communication system of FIG. 1 in establishing a secure wireless connection between a mobile device and a radio programming device and a provisioning of configuration information over the secure wireless connection in accordance with some embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE INVENTION

A communication system is provided that securely provisions configuration information to a mobile device without requiring that a shared key (that is, shared with a radio programming device) be pre-loaded on the mobile device. In various embodiments, the mobile device provides a radio programming device with access point connection information via a scanning tool, which access point connection information includes an access point identifier associated with the mobile device, an access point authentication code, and a one time key (OTK). The radio programming device then uses the access point connection information to access the mobile device when the mobile device is operating as an access point and to provide the mobile device with information for accessing the radio programming device and with an encryption key. The mobile device converts to operation as a client device and then uses the access information and the encryption key to obtain configuration information from the radio programming device.

In one embodiment of the present invention, a method is disclosed for establishing a secure wireless connection for a provisioning of configuration data. The method includes enabling operation of a mobile device as an access point and, when operating as an access point: providing, by the mobile device, an access point identifier associated with the mobile device, an access point authentication code, and a one time key (OTK); establishing, by the mobile device and based on the access point identifier, the access point authentication code, and the OTK, a first wireless connection with a radio programming device; receiving, by the mobile device from the radio programming device and via the first wireless connection, a message comprising radio programming device access information and an encryption key. The method further includes converting, by the mobile device, from operating as an access point to operating as a client device and, when operating as the client device, establishing, by the mobile device and based on the radio programming device access information and the encryption key, a second wireless connection with the radio programming device.

Another embodiment of the present invention encompasses a method for establishing a secure wireless connection for a provisioning of configuration data to a mobile device. The method includes receiving, by a radio programming device from a mobile device, a first message comprising an access point identifier for the mobile device, an access point authentication code associated with the mobile device, and an OTK; establishing, by the radio programming device and based on the access point identifier, the access point authentication code, and the OTK, a first wireless connection with the mobile device, wherein the first wireless connection utilizes access point functionality of the mobile device; conveying, by the radio programming device to the mobile device and via the first wireless connection, a second message comprising radio programming device access information and an encryption key, wherein the encryption key; and establishing, by the radio programming device and based on the radio programming device access information and the encryption key, a second wireless connection with the mobile device, wherein the second wireless connection does not utilize the access point functionality of the mobile device.

Yet another embodiment of the present invention encompasses a mobile device comprising at least one wireless interface, a processor, and an at least one memory device. The at least one memory device is configured to store a set of instructions that, when executed by the processor, cause the processor to perform the following functions: enable operation of the mobile device as an access point and, when operating as an access point: provide an access point identifier associated with the mobile device, an access point authentication code, and an OTK; establish, based on the access point identifier, the access point authentication code, and the OTK, a first wireless connection with a radio programming device; receive, from the radio programming device and via the at least one wireless interface and the first wireless connection, a message comprising radio programming device access information and an encryption key. The at least one memory device further is configured to store a set of instructions that, when executed by the processor, cause the processor to perform the following functions: convert from operating as an access point to operating as a client device and, when operating as the client device, establishing, by the mobile device and based on the radio programming device access information and the encryption key, a second wireless connection with the radio programming device.

Still another embodiment of the present invention encompasses a radio programming device comprising at least one wireless interface, a processor, and an at least one memory device. The at least one memory device is configured to store a set of instructions that, when executed by the processor, cause the processor to perform the following functions: receive, from a mobile device, a first message comprising an access point identifier for the mobile device, an access point authentication code associated with the mobile device, and an OTK; establish, based on the access point identifier, the access point authentication code, and the OTK, a first wireless connection with the mobile device, wherein the first wireless connection utilizes access point functionality of the mobile device; convey, to the mobile device and via the at least one wireless interface and the first wireless connection, a second message comprising radio programming device access information and an encryption key, wherein the encryption key; and establish, based on the radio programming device access information and the encryption key, a second wireless connection with the mobile device, wherein the second wireless connection does not utilize the access point functionality of the mobile device.

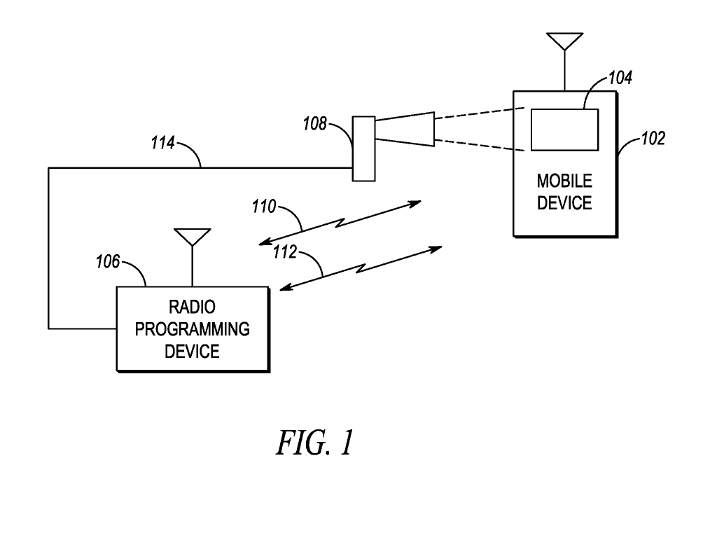

The present invention may be more fully described with reference to FIGS. 1-4B. FIG. 1 is a block diagram of a wireless communication system 100 in accordance with some embodiments of the present invention. Communication system 100 includes mobile device 102, for example but not limited to a cellular telephone, a smart phone, a land mobile radio (LMR), a vehicle modem, a server mounted in vehicle, or a tablet, laptop, or body-worn computing device equipped for wireless communications, etc. In various radio technologies, a mobile device such as mobile device 102 may be referred to as a user equipment (UE), a subscriber station (SS), an access terminal (AT), a mobile station (MS), or the like. Communication system 100 further includes a radio programming device or tool 106 (referred to herein as the ‘radio programming device’) that maintains configuration information for programming a mobile device such as mobile device 102.

Each of mobile device 102 and radio programming device 106 may operate according to multiple wireless communications protocols, including a first wireless local area network (WLAN) protocol for wireless communications over a first air interface 110, such as IEEE 802.11 and variants thereof (“Wi-Fi”), Bluetooth, HiperLAN, ZigBee (IEEE 802.15.4), WiMAX (IEEE 802.16e), and the like, and that is used for short-range communications with an access point, and a second, short-range or longer range wireless protocol for wireless communications over a second air interface 112, again such as the above WLAN protocols or a longer range protocol such as Long Term Evolution (LTE), cellular/wireless telecommunication protocols (e.g. 3G/4G, etc.), Land Mobile Radio (LMR), Digital Mobile Radio (DMR), Terrestrial Trunked Radio (TETRA), Project 25 (P25), Institute of Electrical and Electronics Engineers (IEEE) 802 protocols, and the like. In various embodiments of the present invention, the first and second protocols and first and second air interfaces 110, 112 may be a same protocol and air interface, or different protocols and air interfaces.

Optionally, communication system 100 further may include an image capture device 108 that is coupled, for example, via a wireline connection 114, to radio programming device 106. Image capture device 108 can be any kind of image sensing device, such as a scanning device and/or a camera, capable of reading an image on an image display, such as a display screen 104 of mobile device 102, and producing a copy of the image.

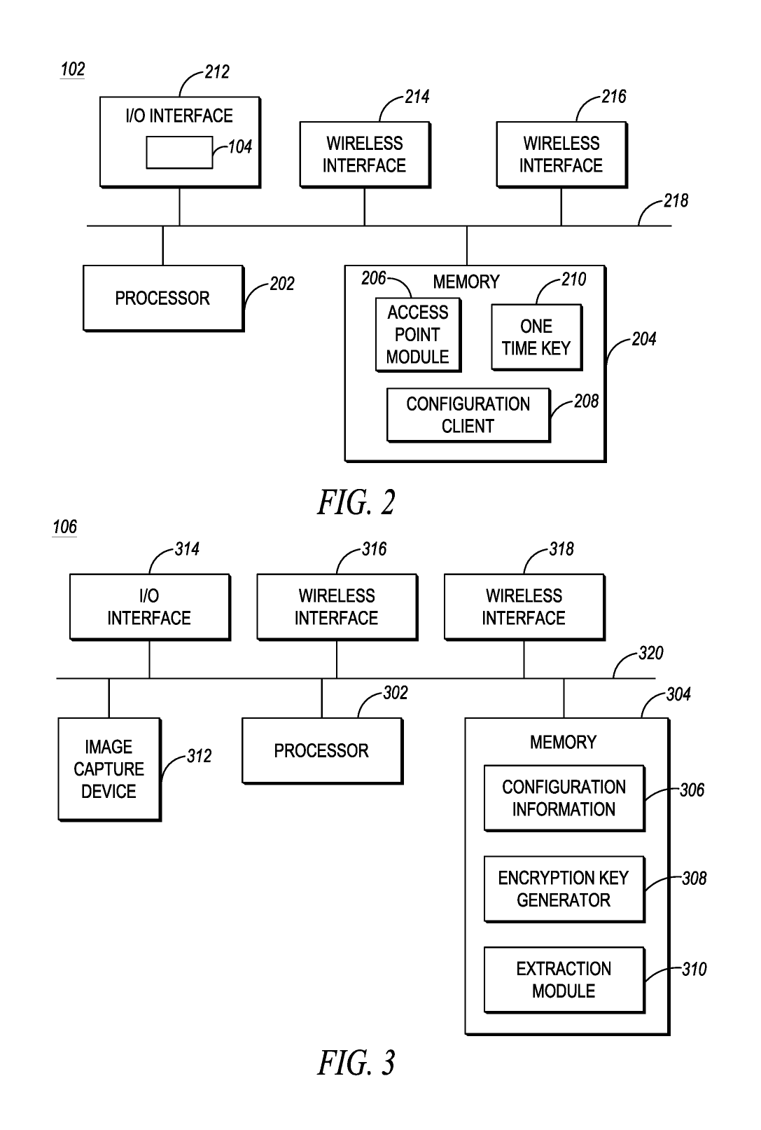

Referring now to FIG. 2, a block diagram of a mobile device 102 is provided in accordance with some embodiments of the present invention. Mobile device 102 generally includes a processor 202, at least one memory device 204, one or more input/output (I/O) interfaces 212, and one or more wireless interfaces 214, 216 (two shown). It should be appreciated by those of ordinary skill in the art that FIG. 2 depicts mobile device 102 in an oversimplified manner, and a practical embodiment may include additional components and suitably configured processing logic to support known or conventional operating features that are not described in detail herein. The components (202, 204, 212, 214, 216) of mobile device 102 are communicatively coupled via a local interface 218. Local interface 218 can be, for example but not limited to, one or more buses or other wired or wireless connections, as is known in the art. Local interface 218 can have additional elements, which are omitted for simplicity, such as controllers, buffers (caches), drivers, repeaters, and receivers, among many others, to enable communications. Further, local interface 218 may include address, control, and/or data connections to enable appropriate communications among the aforementioned components.

Mobile device 102 operates under the control of processor 202, such as one or more microprocessors, microcontrollers, digital signal processors (DSPs), combinations thereof or such other devices known to those having ordinary skill in the art. Processor 202 operates the corresponding mobile device according to data and instructions stored in the at least one memory device 204, such as random access memory (RAM), dynamic random access memory (DRAM), and/or read only memory (ROM) or equivalents thereof, that stores data and instructions that may be executed by the corresponding processor so that the mobile device may perform the functions described herein.

The one or more I/O interfaces 212 include user interfaces that allow a user to input information in, and receive information from, mobile device 102. For example, the user interfaces may include a keypad, a touch screen, a scroll ball, a scroll bar, buttons, bar code scanner, and the like. Further, the user interfaces include display screen 104, such as a liquid crystal display (LCD), touch screen, and the like for displaying system output. I/O interfaces 212 also can include, for example, a serial port, a parallel port, a small computer system interface (SCSI), an infrared (IR) interface, a universal serial bus (USB) interface, and the like for communicating with, or coupling to, an external device, such as image capture device 108. The one or more wireless interfaces 214, 216 facilitate an exchange of wireless communications with radio programming device 106, with other mobile devices (not shown), and with a wireless communications infrastructure (not shown). For example, a first wireless interface 214 of the one or more wireless interfaces 214, 216 includes a transceiver that supports a first, WLAN, for example, Wi-Fi, wireless protocol and a second wireless interface 216 of the multiple wireless interfaces 214, 216 includes a transceiver that supports a second wireless protocol, such as a wireless wide area network (WWAN) protocol, as known in the art.

The data and instructions maintained by at least one memory device 204 include software programs that include an ordered listing of executable instructions for implementing logical functions. For example, the software in at least one memory device 204 includes a suitable operating system (O/S) and programs. The operating system essentially controls the execution of other computer programs, and provides scheduling, input-output control, file and data management, memory management, and communication control and related service. The programs may include various applications, add-ons, etc. configured to provide user functionality with mobile device 102.

For example, at least one memory device 204 maintains an access point module 206 that, when executed by processor 202, facilitates mobile device 102 operating as an access point (AP) in accordance with the first, WLAN wireless protocol, and a configuration client 208 that, when executed by processor 202, facilitates a peer-to-peer exchange of signaling and traffic with radio programming device 106 via the WLAN protocol or a WWAN protocol. Access point module 206 maintains an access point identifier, such as a Service Set Identifier (SSID), that identifies the mobile device when operating as an access point. Access point module 206 further maintains an access point authentication code, that is, a security code that serves to authenticate a device attempting to access mobile device 102 when the mobile device is operating as an access point, such as a WEP/WPA/WPA2 key or a security password.

Additionally, at least one memory device 204 maintains a one-time key (OTK) generator 210, such as a table or an algorithm, that when accessed and/or executed by processor 202 generates an OTK that is used by the mobile device to encrypt an exchange of signaling and data with radio programming device 106. Preferably, the OTK is valid for a single, or a limited number, of bi-directional exchanges of information. For example, the OTK may be a time-limited or a use-limited key, that is, the OTK may expire after a predetermined period of time or the OTK may be valid only for a limited number of hops or for a single download of mobile device configuration information, after which time or use the OTK expires and is no longer a valid key.

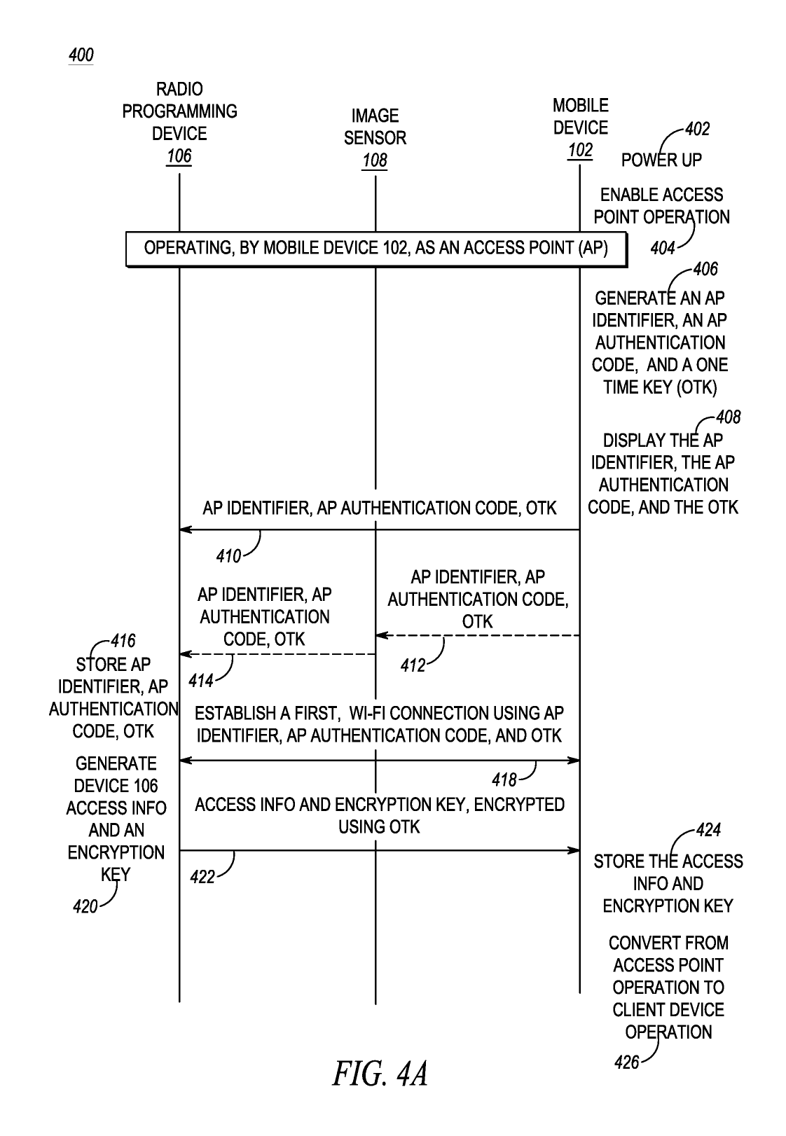

Referring now to FIG. 3, a block diagram is provided of radio programming device 106 in accordance with an embodiment of the present invention. Radio programming device 106 generally includes a processor 302, at least one memory device 304, one or more input/output (I/O) interfaces 314, one or more wireless interfaces 316, 318 (two shown), and optionally an image capture device 312. It should be appreciated by those of ordinary skill in the art that FIG. 3 depicts radio programming device 106 in an oversimplified manner, and a practical embodiment may include additional components and suitably configured processing logic to support known or conventional operating features that are not described in detail herein. The components (302, 304, 312, 314, 316, 318) of radio programming device 106 are communicatively coupled via a local interface 320. Local interface 320 can be, for example but not limited to, one or more buses or other wired or wireless connections, as is known in the art. Local interface 320 can have additional elements, which are omitted for simplicity, such as controllers, buffers (caches), drivers, repeaters, and receivers, among many others, to enable communications. Further, local interface 320 may include address, control, and/or data connections to enable appropriate communications among the aforementioned components.

The data and instructions maintained by at least one memory device 304 include software programs that include an ordered listing of executable instructions for implementing logical functions. For example, the software in at least one memory device 304 includes a suitable operating system (O/S) and programs. The operating system essentially controls the execution of other computer programs, and provides scheduling, input-output control, file and data management, memory management, and communication control and related service. The programs may include various applications, add-ons, etc. configured to provide user functionality with radio programming device 106. Further, at least one memory device 304 maintains configuration information 306 for programming mobile device 102 and an encryption key generator 308, such as a table of keys or a key generation algorithm, that when accessed and/or executed by processor 302 generates an encryption key that may be used to encrypt wireless communications, and an extraction module 310 that, when executed by processor 302, extracts access point connection information from a scanned image, such as a QR code or a bar code.

Image capture device 312 is capable of capturing a displayed image, such as a camera that may be used by a user of radio programming device 106 to capture video and/or still images, or a scanning device, such as a QR scanner or a bar code scanner. The one or more I/O interfaces 314 include user interfaces that allow a user to input information in, and receive information from, radio programming device 106. For example, the user interfaces may include a keypad, a touch screen, a scroll ball, a scroll bar, buttons, bar code scanner, and the like. Further, the user interfaces may include a display screen, such as a liquid crystal display (LCD), touch screen, and the like for displaying system output. I/O interfaces 314 also can include, for example, a serial port, a parallel port, a small computer system interface (SCSI), an infrared (IR) interface, a universal serial bus (USB) interface, and the like for communicating with, or coupling to, an external device, such as image capture device 108.

The one or more wireless interfaces 316, 318 facilitate an exchange of wireless communications with mobile devices, such as mobile device 102, and with a wireless communications infrastructure (not shown). For example, a first wireless interface 316 of the one or more wireless interfaces 316, 318 includes a transceiver that supports a first, WLAN, for example, Wi-Fi, protocol and a second wireless interface 318 of the one or more wireless interfaces 316, 318 includes a transceiver that supports a second wireless protocol, such as a WLAN or a WWAN protocol as known in the art.

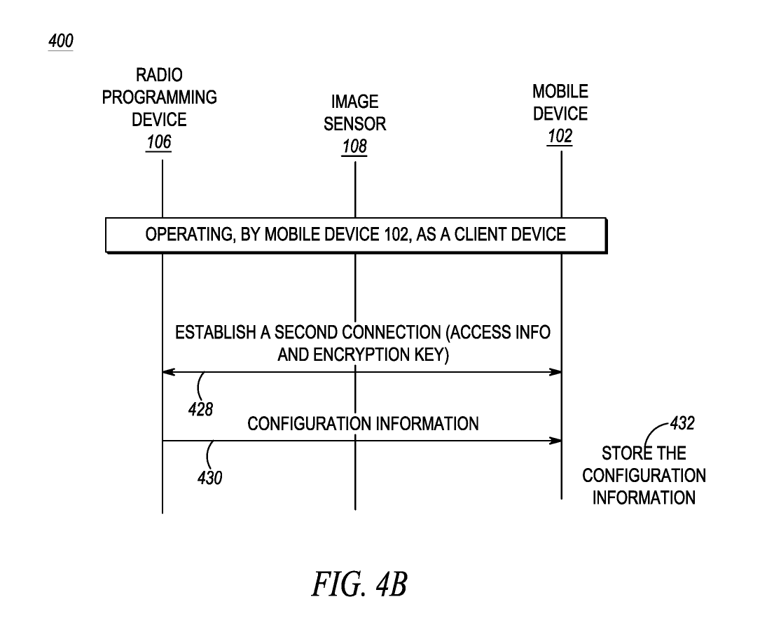

Referring now to FIGS. 4A and 4B, a signal flow diagram 400 is provided that illustrates a method executed by communication system 100 in establishing a secure wireless connection between mobile device 102 and radio programming device 106 and a provisioning of configuration information over the secure wireless connection in accordance with some embodiments of the present invention. Signal flow diagram 400 beings when mobile device 102 first activates (402), for example, powers up, in communication system 100. Concurrent with or subsequent to activating, and by reference to access point module 206 of at least one memory device 204, mobile device 102 enables (404) operation of the mobile device as an access point. That is, mobile device 102 activates the access point functionality of the mobile device and begins operating as an access point.

As part of enabling access point operation, mobile device 102 generates (406), by reference to access point module 206 and OTK generator 210, access point connection information that may be used by radio programming device 106 when the radio programming device attempts to access mobile device 102 when the mobile device is operating as an access point. The access point connection information includes an access point identifier, such as an SSID, that identifies the mobile device when operating as an access point, an access point authentication code, that is, a security code, such as a WEP/WPA/WPA2 key or a security password, that serves to authenticate radio programming device 106 when the radio programming device attempts to access mobile device 102 when the mobile device is operating as an access point, and an OTK that is used by radio programming device 106 to encrypt an exchange of signaling and data with mobile device 102 when the mobile device is operating as an access point.

As mobile device 102 does not yet share any keys with radio programming device 106, the mobile device cannot yet engage in secure wireless communications with the radio programming device 106. Therefore, mobile device 102 may, at this point, prompt a user of the mobile device to request the access point connection information, that is, the access point identifier, the access point authentication code, and the OTK. For example, mobile device 102 may display an icon, for example, a ‘Show Access Point Connection Information’ icon, or text on I/O interface 212, and in particular on display screen 104, which icon or text prompts the user to input a request for access point connection information, or mobile device 102 may play out an audio alert that prompts the user to input request the access point connection information.

In response to prompting the user, mobile device 102 receives an input from the user, for example, by the user selecting the icon or text, requesting that the mobile device display the access point connection information. In response to the receiving request, mobile device 102 displays (408), on I/O interface 212 and in particular on display screen 104, the access point connection information, that is, the access point identifier, the access point authentication code, and the OTK. In various embodiments of the present invention, mobile device 102 may display, on display screen 104, a textual image comprising the text of the access point connection information, or mobile device 102 may convert the access point connection information to a image representation of the access point connection information, such as a QR code or a bar code and display the QR code or bar code on display screen 104.

Radio programming device 106 then obtains (410, 412, 414) a first message comprising the access point connection information, that is, the access point identifier, the access point authentication code, and the OTK, from mobile device 102 by a scanning of the display of the access point connection information on display screen 104. In one embodiment of the present invention, receiving the first message may comprise radio programming device 106 scanning (410), by use of image capture device 312, the access point connection information displayed on display screen 104 of mobile device 102. In another embodiment of the present invention, image capture device 108 may obtain (412) the access point connection information by scanning the display screen of mobile device 102 to produce a scanned image that represents the access point connection information. In such an embodiment, receiving the first message then comprises radio programming device 106 downloading (414) the scanned image from image capture device 108 via wireline connection 114. By using a scanning technique to obtain the access point connection information, instead of mobile device 102 broadcasting the access point connection information, communication system 100 provides a secure exchange of the access point connection information as the information is not sent over the air and the scanning tool, that is, radio programming device 106 or image capture device 108, has to be proximate to the mobile device, and correspondingly to a user of the mobile device, to obtain this information.

In response to obtaining the access point connection information, that is, the access point identifier, the access point authentication code, and the OTK, from mobile device 102, radio programming device 106 stores (416) the access point connection information in at least one memory device 304 of the radio programming device. Radio programming device 106 then establishes (418) a WLAN, for example a Wi-Fi, connection over the first air interface 110 with mobile device 102 using the access point connection information, wherein the mobile device is acting as an access point and the radio programming device is acting as a client device. Further, radio programming device 106 generates (420), by retrieving from at least one memory device 304, access information that may be used by mobile device 102 to access the radio programming device, such as an identifier associated with the radio programming device and/or a network associated with the radio programming device, such as a Service Set Identifier (SSID), a type of security protocol employed by the radio programming device (for example, WEP/WPA/WPA2), one or more security keys, and an encryption key for encrypting and decrypting future communications between the radio programming device and mobile device 102. Preferably, the encryption key is a customer-specific or mobile device-specific key that is valid for use only by a single customer, such as a particular public safety agency, or only by a single mobile device. Radio programming device 106 then conveys (422) a second message to mobile device 102 via the WLAN connection and air interface 110, which message includes the access information and the encryption key and which message is encrypted using the OTK (which OTK now is known to both the radio programming device and the mobile device).

In response to receiving the second message comprising the access information and the encryption key, mobile device 102 stores (424) the access information and the encryption key in at least one memory device 204 and converts (426) from operating as an access point to operating as a client device, for example, ceases operating as an access point and begins operating as a client device. Now operating as a client device, mobile device 102 establishes (428), by executing configuration client 208 of the mobile device, a second, secure connection with radio programming device 106 via second air interface 112 and using the access information and the encryption key received from the radio programming device. After the second, secure connection is established, radio programming device 106 conveys (430) a third one or more messages to mobile device 102, via air interface 112 and using the second, secure connection, which third one or more messages are encrypted by the encryption key and includes configuration information for the mobile device, such as an identifier of an owner of the mobile device, such as a public safety agency or an enterprise identifier, contrast setting for a display screen, various ergonomic parameters, for example, parameters controlling user interaction with the mobile device such as gesture recognition and corresponding command generation and mobile device feedback to the user, talk group configurations for the mobile device, for example, one or more talk group identifiers, audio parameters such as speech codecs to be used, Access Point Name (APN) settings for messaging, and so on. Mobile device 102 then stores (432) the received configuration information in at least one memory device 204, and signal flow diagram then ends.

Thus, by mobile device 102 providing radio programming device 106 with access point connection information via a scanning tool, the radio programming device then using the access point connection information to access the mobile device when the mobile device is operating as an access point and to provide the mobile device with information for accessing the radio programming device and with an encryption key, and the mobile device converting to operation as a client device and using the access information and the encryption key to obtain configuration information from the radio programming device, communication system 100 provides a method for securely provisioning configuration information to mobile device without requiring that a shared key (that is, shared with the radio programming device) be pre-loaded on the mobile device.

The embodiments of the present invention preferably are implemented within mobile device 102 and radio programming device 106, and more particularly with or in software programs and instructions stored in the at least one memory devices 204, 304 and executed by the processors 202, 302 of the mobile device and radio programming device. However, one of ordinary skill in the art realizes that the embodiments of the present invention alternatively may be implemented in hardware, for example, integrated circuits (ICs), application specific integrated circuits (ASICs), and the like, such as ASICs implemented in one or more of mobile device 102 and radio programming device 106, and all references to ‘means for’ herein may refer to any such implementation of the present invention. Based on the present disclosure, one skilled in the art will be readily capable of producing and implementing such software and/or hardware without undo experimentation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes”, “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the expressions “air interface” and “wireless link” are intended to be used interchangeably herein.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for establishing a secure wireless connection for a provisioning of configuration data, the method comprising:
enabling operation of a mobile device as an access point;
when operating as an access point:
providing, by the mobile device, an access point identifier associated with the mobile device, an access point authentication code, and a one time key;
establishing, by the mobile device and based on the access point identifier, the access point authentication code, and the one time key, a first wireless connection with a radio programming device;
receiving, by the mobile device from the radio programming device and via the first wireless connection, a message comprising radio programming device access information and an encryption key;
converting, by the mobile device, from operating as an access point to operating as a client device; and
when operating as the client device, establishing, by the mobile device and based on the radio programming device access information and the encryption key, a second wireless connection with the radio programming device.

2. The method of claim 1, wherein the encryption key is one or more of a customer-specific key and a mobile device-specific key.

3. The method of claim 1, wherein providing the access point identifier, the access point authentication code, and the one time key comprises:
generating, by the mobile device, the access point identifier, the access point authentication code and the one time key; and
displaying, by the mobile device on a display screen, a representation of the access point identifier, the access point authentication code, and the one time key.

4. The method of claim 3, wherein the representation of the access point identifier, the access point authentication code, and the one time key comprises one or more of a QR code, a barcode, or a text.

5. The method of claim 1, further comprising:
receiving, by the mobile device and via the second wireless connection, configuration information.

6. A method for establishing a secure wireless connection for a provisioning of configuration data to a mobile device, the method comprising:
receiving, by a radio programming device from a mobile device, a first message comprising an access point identifier for the mobile device, an access point authentication code associated with the mobile device, and a one time key;
establishing, by the radio programming device and based on the access point identifier, the access point authentication code, and the one time key, a first wireless connection with the mobile device, wherein the first wireless connection utilizes access point functionality of the mobile device;
conveying, by the radio programming device to the mobile device and via the first wireless connection, a second message comprising radio programming device access information and an encryption key, wherein the encryption key; and
establishing, by the radio programming device and based on the radio programming device access information and the encryption key, a second wireless connection with the mobile device, wherein the second wireless connection does not utilize the access point functionality of the mobile device.

7. The method of claim 6, further comprising:
conveying, by the by the radio programming device to the mobile device and via the second wireless connection, a third message comprising configuration information.

8. The method of claim 6, wherein receiving the first message comprises receiving an image.

9. The method of claim 8, wherein the image comprises one or more of a QR code, a barcode, or a text representing the access point identifier, the access point authentication code, and the one time key.

10. The method of claim 8, wherein receiving the first message comprises:
scanning the image on the mobile device.

11. The method of claim 8, wherein receiving the first message comprises:
scanning, by a scanning device, the image on the mobile device to produce a scanned image; and
receiving, by the radio programming device from the scanning device, the scanned image.

12. The method of claim 6, further comprising:
prior to establishing the first wireless connection, enabling, by the mobile device, operation of the mobile device as an access point;
generating, by the mobile device, the access point identifier, the access point authentication code, and the one time key; and
displaying, by the mobile device on a display screen, the access point identifier, the access point authentication code, and the one time key.

13. The method of claim 6, wherein the encryption key is one or more of a customer-specific key and a mobile device-specific key.

14. A mobile device comprising:
at least one wireless interface;
a processor; and
an at least one memory device that is configured to store a set of instructions that, when executed by the processor, cause the processor to perform the following functions:
enable operation of the mobile device as an access point;
when operating as an access point:
provide an access point identifier associated with the mobile device, an access point authentication code, and a one time key;
establish, based on the access point identifier, the access point authentication code, and the one time key, a first wireless connection with a radio programming device;
receive, from the radio programming device and via the at least one wireless interface and the first wireless connection, a message comprising radio programming device access information and an encryption key;
convert from operating as an access point to operating as a client device; and
when operating as the client device, establishing, by the mobile device and based on the radio programming device access information and the encryption key, a second wireless connection with the radio programming device.

15. The mobile device of claim 14, wherein the encryption key is one or more of a customer-specific key and a mobile device-specific key.

16. The mobile device of claim 14, wherein the at least one memory device is configured to store a set of instructions that, when executed by the processor, cause the processor to provide the access point identifier, the access point authentication code, and the one time key by:
generating, by the mobile device, the access point identifier, and the access point authentication code, and the one time key; and
displaying, by the mobile device on a display screen, a representation of the access point identifier, the access point authentication code, and the one time key.

17. The mobile device of claim 14, wherein the at least one wireless interface further is configured to:
receive, via the second wireless connection, configuration information.

18. A radio programming device comprising:
at least one wireless interface;
a processor; and
an at least one memory device that is configured to store a set of instructions that, when executed by the processor, cause the processor to perform the following functions:
receive, from a mobile device, a first message comprising an access point identifier for the mobile device, an access point authentication code associated with the mobile device, and a one time key;
establish, based on the access point identifier, the access point authentication code, and the one time key, a first wireless connection with the mobile device, wherein the first wireless connection utilizes access point functionality of the mobile device;
convey, to the mobile device and via the at least one wireless interface and the first wireless connection, a second message comprising radio programming device access information and an encryption key, wherein the encryption key; and
establish, based on the radio programming device access information and the encryption key, a second wireless connection with the mobile device, wherein the second wireless connection does not utilize the access point functionality of the mobile device.

19. The radio programming device of claim 18, wherein the radio programming device further comprises an image capture device, wherein receiving the first message comprises receiving an image from the mobile device, and wherein the image capture device is configured to scan the image on the mobile device.

20. The radio programming device of claim 18, wherein the radio programming device further comprises an input/output interface, wherein receiving the first message comprises receiving an image from the mobile device, and wherein the input/output interface is configured to receive the image from an image capture device external to the radio programming device.

21. The radio programming device of claim 18, wherein the at least one memory device is configured to store a set of instructions that, when executed by the processor, cause the processor to perform the following functions:
convey, to the mobile device and via the at least one wireless interface and the second wireless connection, a third message comprising configuration information.
